(19) United States
(12) Patent Application Publication
(10) Pub. No.: US 2015/0255961 A1
(43) Pub. Date: Sep. 10, 2015

(54) IONIZER WITH NEEDLE CLEANING DEVICE

(71) Applicant: Desco Industries, Inc., Chino, CA (US)

(72) Inventors: Qinfei Chen, Singapore (SG); Chee Ming Ng, Singapore (SG); Kam Poi Chia, Singapore (SG)

(21) Appl. No.: 14/427,973

(22) PCT Filed: Feb. 28, 2013
(86) PCT No.: PCT/US2013/028126

§ 371 Date: Mar. 12, 2015

Related U.S. Application Data
(60) Provisional application No. 61/700,433, filed on Sep. 13, 2012.

(51) Int. Cl. H01T 23/00; H01T 19/04; B08B 1/00

(52) U.S. Cl. CPC H01T 23/00; B08B 1/001; H01T 19/04

(57) ABSTRACT

A cleaning device for cleaning an ionizing electrode of an ionizer, and ionizers that include a cleaning device for cleaning ionizing electrodes of the ionizer.

### Background

Various types of ion generator or ionizer, for generating air ions by corona discharge and for neutralizing static electricity on an object, have been developed. Such ionizers typically have an electrode needle (or a discharging needle) for generating corona discharge. The discharging performance of the electrode needle may deteriorate, after use, when dirt and dust particles in the air electrostatically adhere to the tip of the needle, or when the surface of the needle becomes oxidized. It is therefore necessary to clean the electrode needle periodically.

U.S. Published Patent Application No. 2010/0188793 describes an ionizer having a cleaning system for cleaning an electrode needle of the ionizer automatically or remotely, while also being compact in size.

### SUMMARY

Corona discharging devices included ionizers that have an ionizing electrode that can generate a corona discharge. The electrode is typically an ionizing electrode needle, having a sharp point. It is necessary to clean the electrode of an ionizer at a proper time interval. However, the ionizer may be used in a continuously operated system, such as semiconductor production equipment, and it is typically inefficient and undesirable to stop the system for cleaning of the ionizing electrode. It is also desirable to avoid manual cleaning of the ionizing electrode. Therefore, it is desired to clean the ionizing electrode automatically or remotely.

In a first aspect, the present disclosure provides a cleaning device for cleaning an ionizing electrode of an ionizer, the cleaning device including an arm having a cleaning head. The cleaning head includes a housing and a cleaner disposed within the housing. The arm has an adjustable length and is adapted to expand to a longer first length and contract to a shorter second length. When the arm expands to the longer first length, the cleaning head can receive an ionizing electrode of an ionizer within the housing so that the cleaner can clean the ionizing electrode, and when the arm contracts to the shorter second length, the cleaning head is adapted to be distanced from the ionizing electrode.

In a second aspect, the present disclosure provides an ionizer, including: at least one ionizing electrode for ionizing air; and the cleaning device disclosed in the first aspect.

In a third aspect, the present disclosure provides an ionizer, including: a plurality of ionizing electrodes for ionizing air, the ionizing electrodes being arranged on a first perimeter of a first circle. An ionizing tip of each ionizing electrode points toward a first center of the first circle. The ionizer also includes an arm having a cleaning head. The cleaning head includes a housing and a cleaner disposed within the housing. The arm has an adjustable length and is adapted to expand to a longer first length and contract to a shorter second length. A first end of the arm is attached to the ionizer at the first center of the first circle, the attachment providing a pivot. An opposing second end of the arm is adapted to rotate about the pivot when the arm is contracted to the shorter second length and stop at each ionizing electrode in the plurality of ionizing electrodes, such that when the second end stops at an ionizing electrode, the cleaning head faces and is distanced from the ionizing tip of the ionizing electrode. The arm is adapted to expand to the longer first length so that the cleaning head receives the ionizing electrode within the housing and the cleaner cleans the ionizing electrode.

### BRIEF DESCRIPTION OF DRAWINGS

FIG. 1 is a perspective view of an ionizer of the present description;

FIGS. 2A and 2B are cross-sectional views of an ionizer of the present description;

FIGS. 3A and 3B are cross-sectional views of an ionizer of the present description;

FIG. 4A is a perspective view of an ionizer of the present description, and FIG. 4B is an enlargement of a portion of FIG. 4A;

FIG. 5 is an electronic circuit diagram for a circuit of a reflective object sensor switch;

FIG. 6 is an electronic circuit diagram for a circuit stepper motor controller; and

FIG. 7 is a flow diagram for operation of an ionizer of the present description.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom“, “upper”, lower“, “under”, “over”, “front”, “back”, “outward”, “inward”, “up” and “down”, and “first” and “second” may be used in this disclosure, it should be understood that those terms are used in their relative sense only unless otherwise noted. In particular, in some embodiments certain components may be present in interchangeable and/or identical multiples (e.g., pairs). For these components, the designation of “first” and “second” may apply to the order of use, as noted herein (with it being irrelevant as to which one of the components is selected to be used first).

### DETAILED DESCRIPTION

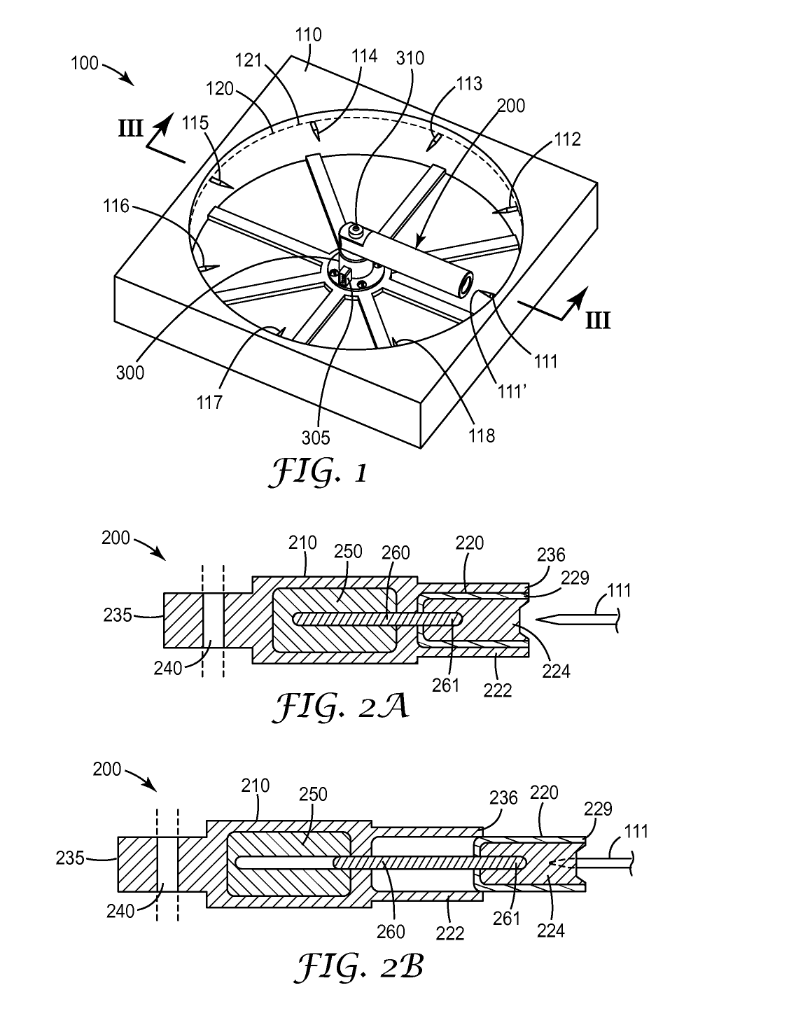

FIG. 1 shows a schematic view of an ionizer 100 according to a first embodiment of the present disclosure. Ionizer 100 can generate positive and negative ions for canceling charges that build up in regions of interest, for example, during the automated manufacture of electronic devices. The ionizer may be equipped with a fan (not shown) to blow air through the ionizer and deliver air ions for canceling charges in the regions of interest. Ionizer 100 includes a housing 110, and a plurality of ionizing electrodes 111 to 118 in the housing, for generating air ions by corona discharge. Ionizer 100 is typically connected to high-voltage power supplies (not shown) for applying high voltage to the ionizing electrodes 111 to 118. The ionizing electrodes can be susceptible to oxidation or the accumulation of dust and dirt.

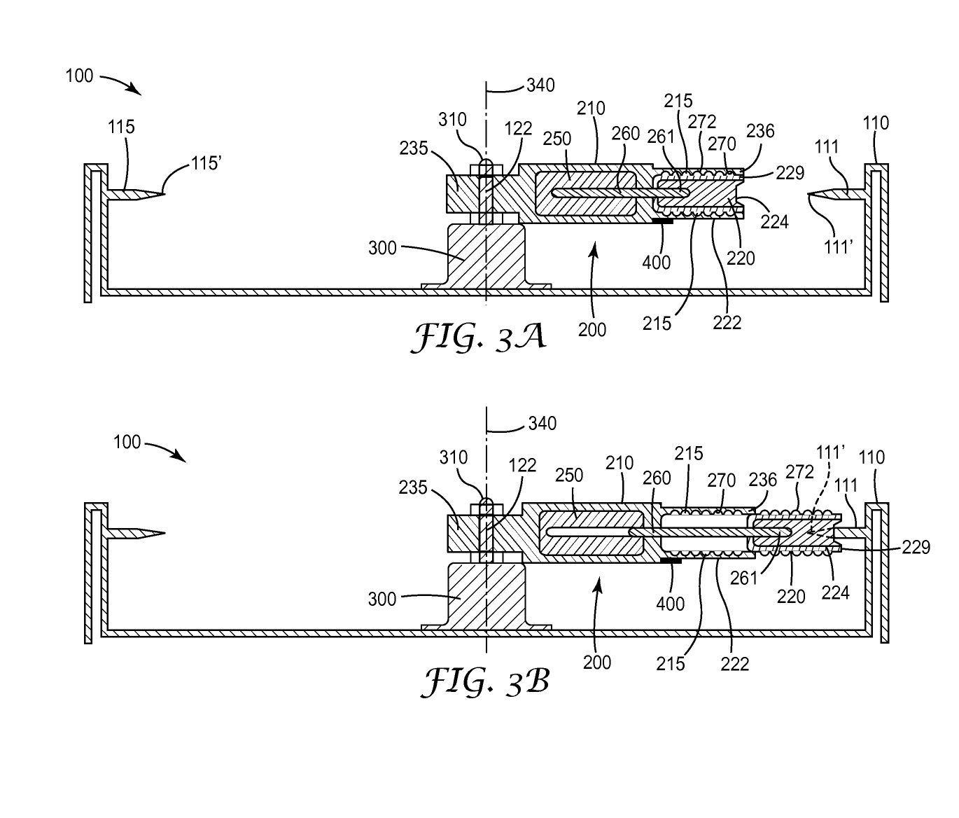

In the embodiment shown, each ionizing electrode 111 to 118 is arranged within housing 110 around a first perimeter 121 of a first circle 120, with an ionizing tip 111′ to 118′ of each ionizing electrode 111 to 118 pointing toward a first center 122 of first circle 120 (see FIGS. 3A and 3B for location of first center 122). In this embodiment, there are eight ionizing electrodes, while in other embodiments there may be more or fewer ionizing electrodes. Typically, the ionizing electrodes are arranged in pairs, on opposite positions of first circle 120. The ionizing electrodes may be evenly spaced around first circle 120, or in other embodiments may be unevenly spaced around first circle 120.

Ionizer 100 includes a cleaning device 200 for cleaning ionizing electrodes. FIGS. 2A and 2B show cross-sectional views of cleaning device 200, including an arm 210 that has a cleaning head 220. Arm 210 has a first end 235 and an opposing second end 236. First end 235 can optionally include an opening 240 suitable for fitting first end 235 onto a rotatable axle (e.g., axle 310 on a motor 300 in FIGS. 1, 3A, and 3B), for turning arm 210. Arm 210 has an adjustable length and is adapted to expand to a first longer length, as illustrated in FIG. 2B, in order to move cleaning head 220 out of sleeve 222 and towards the ionizing tip of an ionizing electrode (e.g., ionizing electrode 111). Arm 210 is also adapted to contract to a shorter second length, as shown in FIG. 2A, in order to retract cleaning head 220 away from the ionizing electrode after cleaning the ionizing tip, and back into sleeve 222. In FIGS. 1, 2A, and 2B, arm 210 and cleaning head 220 are both shown as cylindrical, although arm 210 and cleaning head 220 can each independently have other, different, shapes, provided that cleaning head 220 is configured to receive a portion of the ionizing electrode.

Cleaning head 220 includes housing 229 that houses cleaner 224, and it is cleaner 224 that comes into physical contact with an ionizing electrode to remove surface oxidation buildup or accumulated dust and dirt. In some embodiments, cleaner 224 includes a sponge (not shown) or other similar materials inside of cleaner 224 that can be elastic and that can hold an ionizing electrode during a cleaning. The portion of cleaner 224 that comes into contact with an ionizing electrode may be coated with a thin film of adhesive suitable for removing dust particles from an ionizing electrode. Cleaner 224 is removable from housing 229, and cleaner 224 typically is replaced after a determined number of cleaning uses.

In the embodiment shown in FIGS. 2A and 2B, arm 210 includes a solenoid 250 adapted to control the contracting and extending of arm 210. Solenoid 250 has tongue 260, and cleaning head 220 is mounted on end portion 261 of tongue 260. FIG. 2B shows tongue 260 extruded from solenoid 250, and cleaning head 220 moved towards an ionizing electrode. Solenoid 250 can be operated by any suitable electrical circuit (e.g., a relay switch circuit). Solenoid 250 is typically operated under the control of a microprocessor (not shown). Other suitable mechanisms for controlling the contracting and extending of arm 210 may be used (e.g., air-assisted or mechanical pulley systems).

FIG. 3A is a cross-sectional view of ionizer 100 along line III-III in FIG. 1, showing cleaning device 200, including arm 210 having first end 235 and second end 236. First end 235 is attached to ionizer 100 at the first center 122 of first circle 120. In the embodiment shown, first end 235 is attached to an axle 310 of a motor 300, the attachment providing a pivot point for arm 210 around an axis 340 that runs through first center 122, perpendicular to a plane containing first circle 120. Second end 236 is adapted to rotate about the pivot when arm 210 is contracted to the shorter second length, and to stop opposite each ionizing electrode in the plurality of ionizing electrodes 111 to 118. In operation, when arm 210 is rotated around the pivot point and second end 236 stops opposite an ionizing electrode (e.g., ionizing electrode 111), cleaning head 220 faces and is distanced from ionizing tip (e.g., ionizing tip 111′) of the ionizing electrode. Arm 210 is then expanded to move second end 236 to the longer first length, so that cleaning head 220 moves out of sleeve 222 and receives the ionizing electrode for cleaning, as shown in FIG. 3B.

In FIG. 3B, cleaning head 220 is shown receiving ionizing electrode 111 within housing 229 so that cleaner 224 cleans the ionizing electrode. Once the ionizing electrode has been in contact with cleaner 224, arm 210 can then be contracted back to the shorter second length, withdrawing cleaning head 220 from ionizing electrode 111 and back into sleeve 222. Cleaning head 220 is thus again distanced from the ionizing electrode, returned to the position seen in FIG. 3A. Second end 236 can then be moved, positioning cleaning head 220 opposite another ionizing electrode (e.g., ionizing electrode 112), and the cleaning process is repeated. Typically, movement of arm 210 is controlled by a microprocessor (not shown).

Also shown in the FIGS. 3A and 3B are threaded interior surface 270 of sleeve 222, and threaded exterior surface 272 of housing 229. Threaded interior surface 270 is complementary to threaded exterior surface 272, and in FIG. 3A threaded interior surface 270 is shown as engaging threaded exterior surface 272. Spiral threads 215 on threaded interior surface 270 can be configured to axially rotate cleaning head 220 as it is extended to receive the ionizing electrode. In some embodiments, cleaning head 220 is rotatably mounted on end portion 261 of tongue 260, to permit axial rotation of cleaning head 220. In some other embodiments, cleaning head 220 is fixed to end portion 261 and does not rotate around tongue 260, but tongue 260 is axially rotatable within solenoid 250, again to permit axial rotation of cleaning head 220. The axial rotation of cleaning head 220 provides additional cleaning force when cleaning head 220 receives ionizing electrode 111. In some embodiments, arm 200 is adapted to expand to a longer first length when housing 229 threadably moves within sleeve 222 in one direction (e.g., clockwise axial rotation, as viewed from ionizing electrode 111), and arm 200 is adapted to contract to a shorter second length when housing 229 threadably moves within sleeve 222 in an opposite direction (e.g., counter-clockwise axial rotation, as viewed from ionizing electrode 111). In some other embodiments (not shown), threaded interior surface 270 and threaded exterior surface 272 may have substantially straight tracks aligned with the ionizing electrode, in which case cleaning head 220 would not rotate axially during the movement of cleaning head 220 towards an ionizing electrode.

Axel 310 of motor 300 can be rotated under automated control to align arm 210 with the position of each ionizing electrode 111 to 118. Axel 310 can be rotated to move arm 210 in either a clockwise or an anti-clockwise direction, relative to the view shown in FIG. 1.

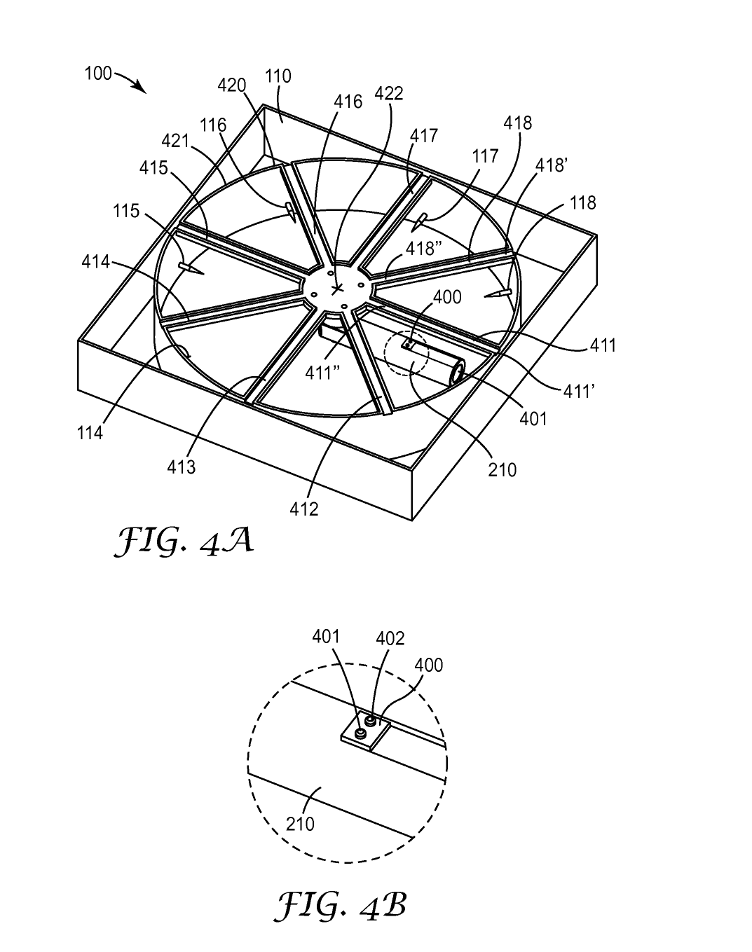

FIG. 4A shows a perspective view of an exemplary embodiment of ionizer 100, shown from the opposite side of that shown in FIG. 1. Ionizer 100 includes a plurality of longitudinal rods 411 to 418 arranged on a second perimeter 421 of a second circle 420 above the first circle 120. All of the longitudinal rods 411 to 418 are shown as attached to one another at a second center 422 of the second 420 circle above the first center of first circle 120. Each of longitudinal rods 411 to 418 is associated with a different ionizing electrode 111 to 118, first ends of longitudinal rods 411 to 418 being located proximate their respective ionizing electrodes 111 to 118 (e.g., longitudinal rod 411 has first end 411′ located proximate ionizing electrode 111, and longitudinal rod 418 has first end 418′ located proximate ionizing electrode 118). In the embodiment shown in FIG. 4, longitudinal rods 411 to 418 are joined together (e.g., second ends 411″ and 418″ are joined via a central portion that includes second center 422) to aid in providing a support structure for motor 300. It will be understood that other configurations of the longitudinal rods will also be possible, where some of the rods may be joined at only one end, to either the housing 110 of ionizer 100, or joined near the second center 422 to one or more of the other longitudinal rods. In some embodiments, the longitudinal rods serve as locators for positioning of arm 210 for cleaning of each ionizing electrode 111 to 118. In typical embodiments, each ionizing electrode 111 to 118 has a corresponding longitudinal rod 411 to 418 aligned with it, and a reflective object sensor 400 associated with arm 210 can then be used to sense the location of each longitudinal rod 411 to 418, and thereby locate the position of each ionizing electrode 111 to 118 for aligning arm 210 with each ionizing electrode.

FIG. 4B shows an enlarged portion of FIG. 4A, showing reflective object sensor 400 attached to arm 210. Reflective object sensor 400 includes an emitter 401 and a detector 402 disposed on arm 210. Emitter 401 is adapted to emit a signal in a direction perpendicular to first circle 120 toward second circle 420, such that when second end 236 of arm 210 rotates about the pivot and is aligned with one of the longitudinal rods 411 to 418, the longitudinal rod reflects the signal emitted by emitter 401 toward detector 402, the detector 402 detects the reflected signal, the signal detection causing arm 210 to stop with cleaning head 220 facing the ionizing tip of the ionizing electrode corresponding to the longitudinal rod. In a typical embodiment, solenoid 250 would then be energized to expand arm 210 to the longer first length, so that cleaning head 220 receives the ionizing electrode, and cleaner 224 cleans the ionizing needle.

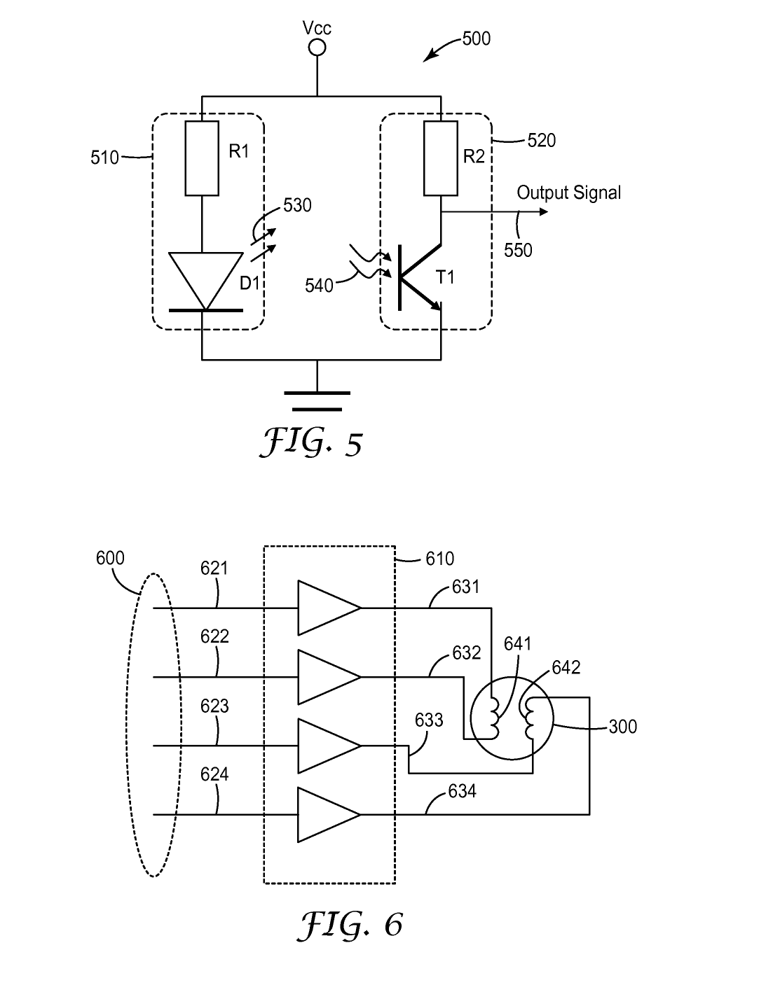

FIG. 5 shows a circuit diagram for a reflective object sensor 500 that includes emitter 510 and detector 520 connected to a positive voltage supply (WO and an electrical ground. D1 is transmitter, T1 is receiver, and R1 and R2 are current limit resistors. D1 is typically an infrared light emitting diode, emitting infrared light 530, and T1 is typically a phototransistor capable of responding to reflected infrared light 540. In typical embodiments, emitter 510 and detector 520 are arranged on arm 210 so that when arm 210 is aligned with one of the longitudinal rods 411 to 418, infrared light 530 from emitter 510 is reflected from arm 210. The reflected infrared light 540 is then detected by detector 520, which can in turn trigger an interrupt signal to a microcontroller (not shown) via lead 550. The interrupt signal can signal the microcontroller to stop motor 300 with cleaning head 220 aligned with one of ionizing electrodes 111 to 118, in position for a cleaning the corresponding ionizing tip.

Typically, motor 300 is a stepper motor that is controlled and driven by motor drive electrical circuitry. Examples of a suitable stepper motor include permanent magnet stepper motors and hybrid-type stepper motors. As shown in FIG. 1, motor 300 typically includes a connector 305 for connection to microcontroller controls (microcontroller controls not shown in FIG. 1).

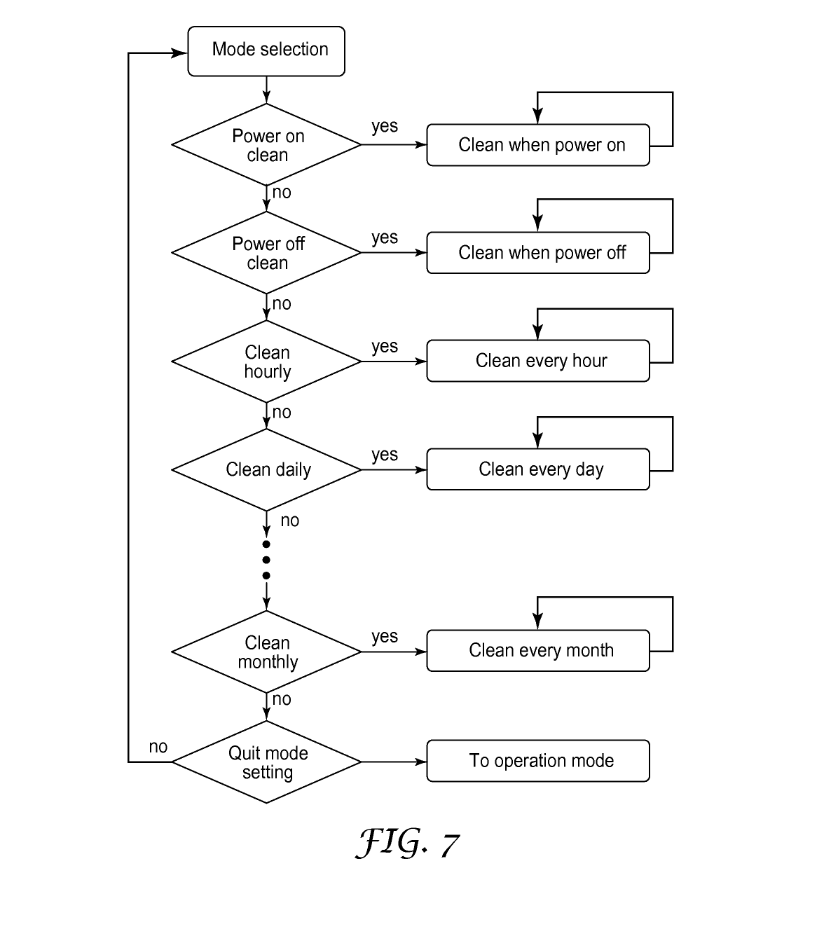

FIG. 6 shows a suitable motor drive electrical circuitry that includes microcontroller 600 having pins connected to inputs 621 to 624 of driver unit 610. Driver unit 610 has output leads 631 to 634 attached to coils 641 and 642 of motor 300. Microcontroller 600 generates electrical pulses that flow sequentially through output leads 631 to 634 of driver unit 610 and into coils 641 and 642 to drive motor 300. In some embodiments, a typical current required to drive a suitable stepper motor is in a range of 300 milliamps to 600 milliamps.

FIG. 7 shows a flow diagram of an embodiment of using a microcontroller for operation of a cleaning device of the present description. A user selects a mode of operation that may include any of cleaning each of the ionizer electrodes 111 to 118 at “power on”, at “power off”, cleaning hourly, cleaning daily, cleaning monthly, or any suitable schedule of the ionizer needles. The user may also select a “Quit” mode to turn off the cleaning device. Typically, the microcontroller includes suitable electrical calendar circuitry to support scheduling of cleanings. In typical embodiments, the microcontroller includes an ability to disable the application of high voltages to the ionizing electrodes prior to and during a cleaning operation. After completion of the cleaning operation, the microcontroller would then re-enable the application of high voltages to the ionizing electrodes for normal operation of the ionizer.

In the above embodiments, a direct-current (DC) ionizer is described. However, the invention may also be applied to an alternating-current ionizer (AC ionizer). In the AC ionizer, it is not necessary to arrange electrode needles at the opposed positions. For example, the AC ionizer may have only one electrode needle. In the AC ionizer, all electrode needles may be electrically connected to one AC power supply, and corona discharging is generated between each electrode needle and an electrode opposed to each electrode needle.

Various items are provided that are cleaning devices or ionizers that include a cleaning device:

Item 1. A cleaning device for cleaning an ionizing electrode of an ionizer, the cleaning device including: an arm including a cleaning head including: a housing; and a cleaner disposed within the housing; the arm having an adjustable length and being adapted to expand to a longer first length and contract to a shorter second length, such that when the arm expands to the longer first length, the cleaning head is adapted to receive an ionizing electrode of an ionizer within the housing so that the cleaner can clean the ionizing electrode, and when the arm contracts to the shorter second length, the cleaning head is adapted to be distanced from the ionizing electrode.

Item 2. The cleaning device of item 1, wherein the arm includes a sleeve having a threaded interior surface, and wherein the housing is disposed within the sleeve and includes a threaded exterior surface engaging the threaded interior surface of the sleeve.

Item 3. The cleaning device of item 2, wherein the arm is adapted to expand to a longer first length when the housing threadably moves within the sleeve in one direction and the arm is adapted to contract to a shorter second length when the housing threadably moves within the sleeve in an opposite direction

Item 4. The cleaning device of any one of items 1 to 3, wherein the arm has a fixed end adapted to be attached to an ionizer and an opposing free end adapted to move closer to or farther away from an ionizing electrode of an ionizer, the cleaning head being at the free end of the arm.

Item 5. The cleaning device of item 4, wherein when the fixed end of the arm is attached to an ionizer, the attachment provides a pivot, the arm being adapted to rotate about the pivot.

Item 6. The cleaning device of any one of items 1 to 5, wherein when the cleaner cleans an ionizing electrode of an ionizer, the cleaner is adapted to retain at least a substantial portion of what is removed from the ionizing electrode within the housing.

Item 7. The cleaning device of any one of items 1 to 6, wherein the arm includes a first hollow portion along the length and at an end of the arm, the cleaning head being disposed within the first hollow portion.

Item 8. The cleaning device of item 7, wherein the arm includes a second hollow portion disposed along the length of the arm between the first hollow portion and an opposing end of the arm.

Item 9. The cleaning device of item 8, wherein the arm includes a solenoid disposed within the second hollow portion of the arm for expanding the arm to the longer first length and contracting the arm to the shorter second length.

Item 10. An ionizer, including: at least one ionizing electrode for ionizing air; and the cleaning device of any one of items Ito 9.

Item 11. An ionizer, including:

a plurality of ionizing electrodes for ionizing air, the ionizing electrodes being arranged on a first perimeter of a first circle, an ionizing tip of each ionizing electrode pointing toward a first center of the first circle; and

an arm including a cleaning head including:
a housing; and
a cleaner disposed within the housing;

the arm having an adjustable length and being adapted to expand to a longer first length and contract to a shorter second length, a first end of the arm being attached to the ionizer at the first center of the first circle, the attachment providing a pivot, an opposing second end of the arm being adapted to rotate about the pivot when the arm is contracted to the shorter second length and stop at each ionizing electrode in the plurality of ionizing electrodes, such that when the second end stops at an ionizing electrode, the cleaning head faces and is distanced from the ionizing tip of the ionizing electrode, the arm being adapted to expand to the longer first length so that the cleaning head receives the ionizing electrode within the housing and the cleaner cleans the ionizing electrode.

Item 12. The ionizer of item 11, wherein the arm includes a sleeve having a threaded interior surface, and wherein the housing is disposed within the sleeve and includes a threaded exterior surface engaging the threaded interior surface of the sleeve.

Item 13. The ionizer of item 12, wherein the arm is adapted to expand to a longer first length when the housing threadably moves within the sleeve in one direction and the arm is adapted to contract to a shorter second length when the housing threadably moves within the sleeve in an opposite direction.

Item 14. The ionizer of any one of items 11 to 13, further including a motor for rotating the arm about the pivot.

Item 15. The ionizer of any one of items 11 to 14, further including a plurality of longitudinal rods, first ends of the rods being arranged on a second perimeter of a second circle above the first circle, opposing second ends of the rods being attached to one another at a second center of the second circle above the first center, each rod being associated with a different ionizing electrode, the first end of the rod being above the ionizing electrode.

Item 16. The ionizer of item 15, further including an emitter and a detector disposed on the arm, the emitter being adapted to emit a signal in a direction perpendicular to the first circle toward the second circle, such that when the second end of the arm rotates about the pivot and reaches a rod, the rod reflects the signal emitted by the emitter toward the detector, the detector detects the reflected signal, the signal detection causing the arm to stop with the cleaning head facing the ionizing tip of the ionizing electrode corresponding to the rod.

What is claimed is:

1. A cleaning device for cleaning an ionizing electrode of an ionizer, the cleaning device comprising:
an arm comprising a cleaning head comprising:
a housing; and
a cleaner disposed within the housing;
the arm having an adjustable length and being adapted to expand to a longer first length and contract to a shorter second length, such that when the arm expands to the longer first length, the cleaning head is adapted to receive an ionizing electrode of an ionizer within the housing so that the cleaner can clean the ionizing electrode, and when the arm contracts to the shorter second length, the cleaning head is adapted to be distanced from the ionizing electrode.

2. The cleaning device of claim 1, wherein the arm comprises a sleeve having a threaded interior surface, and wherein the housing is disposed within the sleeve and comprises a threaded exterior surface engaging the threaded interior surface of the sleeve.

3. The cleaning device of claim 2, wherein the arm is adapted to expand to a longer first length when the housing threadably moves within the sleeve in one direction and the arm is adapted to contract to a shorter second length when the housing threadably moves within the sleeve in an opposite direction

4. The cleaning device of claim 1, wherein the arm has a fixed end adapted to be attached to an ionizer and an opposing free end adapted to move closer to or farther away from an ionizing electrode of an ionizer, the cleaning head being at the free end of the arm.

5. The cleaning device of claim 4, wherein when the fixed end of the arm is attached to an ionizer, the attachment provides a pivot, the arm being adapted to rotate about the pivot.

6. The cleaning device of claim 1, wherein when the cleaner cleans an ionizing electrode of an ionizer, the cleaner is adapted to retain at least a substantial portion of what is removed from the ionizing electrode within the housing.

7. The cleaning device of claim 1, wherein the arm comprises a first hollow portion along the length and at an end of the arm, the cleaning head being disposed within the first hollow portion.

8. An ionizer, comprising:
a plurality of ionizing electrodes for ionizing air, the ionizing electrodes being arranged on a first perimeter of a first circle, an ionizing tip of each ionizing electrode pointing toward a first center of the first circle; and
an arm comprising a cleaning head comprising:
a housing; and
a cleaner disposed within the housing;
the arm having an adjustable length and being adapted to expand to a longer first length and contract to a shorter second length, a first end of the arm being attached to the ionizer at the first center of the first circle, the attachment providing a pivot, an opposing second end of the arm being adapted to rotate about the pivot when the arm is contracted to the shorter second length and stop at each ionizing electrode in the plurality of ionizing electrodes, such that when the second end stops at an ionizing electrode, the cleaning head faces and is distanced from the ionizing tip of the ionizing electrode, the arm being adapted to expand to the longer first length so that the cleaning head receives the ionizing electrode within the housing and the cleaner cleans the ionizing electrode.

9. The ionizer of claim 8, wherein the arm comprises a sleeve having a threaded interior surface, and wherein the housing is disposed within the sleeve and comprises a threaded exterior surface engaging the threaded interior surface of the sleeve.

10. The ionizer of claim 9, wherein the arm is adapted to expand to a longer first length when the housing threadably moves within the sleeve in one direction and the arm is adapted to contract to a shorter second length when the housing threadably moves within the sleeve in an opposite direction.
